(19) United States
(12) Patent Application Publication
(10) Pub. No.: US 2003/0048479 A1
(43) Pub. Date: Mar. 13, 2003

(54) Apparatus and method for image processing

(76) Inventor: Tetsushi Hirano, Fukuoka (JP)

Correspondence Address: RATNERPRESTIA, P O BOX 980, VALLEY FORGE, PA, 19482-0980, US

(21) Appl. No.: 10/214,905

(22) Filed: Aug. 8, 2002

(30) Foreign Application Priority Data
Aug. 9, 2001 (JP) 2001-242898

(51) Int. Cl. H04N 1/405

(52) U.S. Cl. 358/3.14; 358/3.23

(57) ABSTRACT

The image processing apparatus disclosed performs as follows:

(a) a plurality of conversion matrices in data selector stores binary image that is dither-processed in accordance with image density,

(b) a conversion matrix selector selects a matrix out of a plurality of conversion matrices for an input multi-level image,

(c) an address generator receives signal of the selection,

(d) a binary image, that is dither-processed in selected conversion matrix, is entered into a data selector having a plurality of conversion matrices and

(e) the data selector selects a required binary image, and outputs the converted binary image.

### FIELD OF THE INVENTION

The present invention relates to an image processing apparatus and a method for converting multi-level images into binary images.

### BACKGROUND OF THE INVENTION

Multi-gradation image stored in a computer is output in binary gradation image for media equipment capable of generating binary gradation only, such as printer or facsimile, by means of an image processing apparatus and a method for converting multi-level image into binary image.

In the conversion processing, binary digital halftoning of an image must be generated using the ordered-dither-method, a generally known conventional art for this purpose, to maintain an original image quality as much as possible. Such ordered-dither-method is discussed in generalities in Hitoshi Takaya, “Easy to understand Digital Image Processing”, QC Press, ISBN4-7898-3677-0, 1996.

A conventional apparatus for converting multi-level image into binary image is described with reference to FIG. 4.

FIG. 4 shows a schematic view of a conventional image processing apparatus. In FIG. 4, image processing apparatus 406 to convert multi-level images into binary images comprises:

(1) input port 404 for multi-level images;

(2) address generator 401 for dither matrix;

(3) dither matrix 402 to store threshold information;

(4) comparator 403 to compare multi-level image and threshold information from dither matrix 402; and

(5) output port 405 for converted binary images.

FIG. 5 is a schematic view of a conventional dither matrix, showing data of dither matrix for one pixel 501.

An operation of conventional image processing apparatus 406, having above configuration, to convert a multi-level image into a binary image is described with reference to FIG. 4 and FIG. 5.

Address generator 401 calculates dither matrix coordinates and generates address information. The generated address information is stored in dither matrix 402 to select required dither matrix coordinates and then threshold information is read out. The threshold information and multi-level image from input port 404 are sent to comparator 403. After comparison, converted result is output in binary image from output port 405.

Dither matrix 402 has such a configuration as shown in FIG. 5, when both input multi-level image and dither matrix 402 are represented by 8 bits data. Therefore, 8-bit data, a bit length of threshold information for one pixel 501 of dither matrix 402 in FIG. 5, is required to convert one pixel of multi-level image into binary image.

In this regard, input data of multi-level image and threshold information of dither matrix employs, usually, an identical bit length to maintain an original gradation of multi-level image.

Above mentioned conventional method and configuration, however, requires a data length for one pixel of correspondent threshold information of dither matrix, to convert data of one pixel into binary image data. In many cases, a bit length of one pixel of threshold information on dither matrix employs an identical bit length as input data of multi-level image to maintain an original gradation of multi-level image. Consequently, an amount of 8 bits information is required.

As is clear from above, drawback is that a conventional processing system to convert into binary image must read out a great amount of data causing long processing time.

### SUMMARY OF THE INVENTION

The invention discloses an image processing apparatus for converting multi-level images into binary images, the apparatus comprises:

(a) a plurality of conversion matrix to store binary image that is dither-processed in accordance with image density,

(b) a conversion matrix selector to select a matrix out of a plurality of conversion matrices for an input multi-level image,

(c) an address generator to generate addresses of conversion matrix, and

(d) a data selector to select and output a required binary image that is dither-processed and read out from a conversion matrix.

### BRIEF DESCRIPTION OF THE DRAWINGS

FIG. 1 is a block diagram of configuration for image processing apparatus used in the preferred embodiment of the present invention.

FIG. 2 is a schematic view of a conversion matrix used in the preferred embodiment of the present invention.

FIG. 3 is a flowchart of an image processing method used in the in the preferred embodiment of the present invention.

FIG. 4 is a block diagram of configuration of conventional image processing apparatus.

FIG. 5 is a schematic view of a conventional dither matrix.

### DESCRIPTION OF THE PREFERRED EMBODIMENTS

Preferred Embodiment

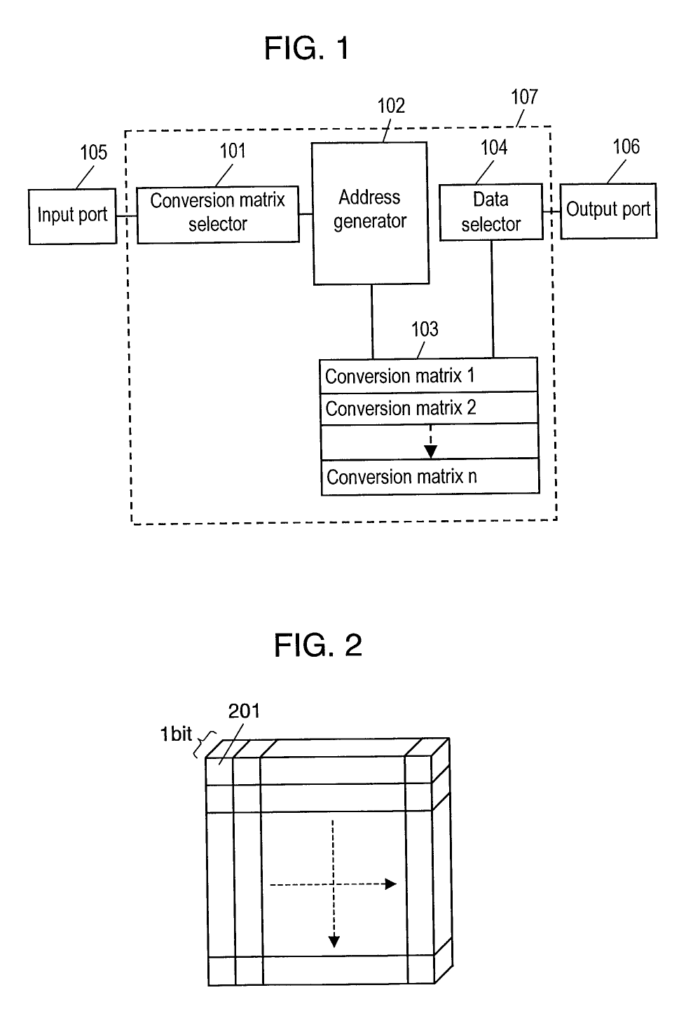

The present invention is explained by following preferred embodiment with reference to FIG. 1 and FIG. 2. FIG. 1 shows a block diagram of configuration for image processing apparatus used in the preferred embodiment of the present invention. In FIG. 1, an image processing apparatus disclosed in the present invention includes input port 105, conversion matrix selector 101, address generator 102, data selector 104, a plurality of conversion matrix 103 and output port 106.

In FIG. 1, conversion matrix selector 101 selects a conversion matrix 103 corresponding a multi-level image sent from input port 105, then provides address generator 102 with signal of the selection.

The multi-level image is processed using a conversion matrix selected out of a plurality of conversion matrix 103. Binary image output by the ordered dither method is sent to data selector 104 to select a binary image required. A binary image resulting from the conversion is sent to output port 106 and the processing finishes.

FIG. 2 shows a schematic view of a conversion matrix used in the preferred embodiment of the present invention. One pixel data 201 in conversion matrix is shown in FIG. 2. A binary image resulting from dither method processing, corresponding image density, is stored in conversion matrix. As shown in the drawing, 1 bit information is needed for a data of one pixel in a binary image.

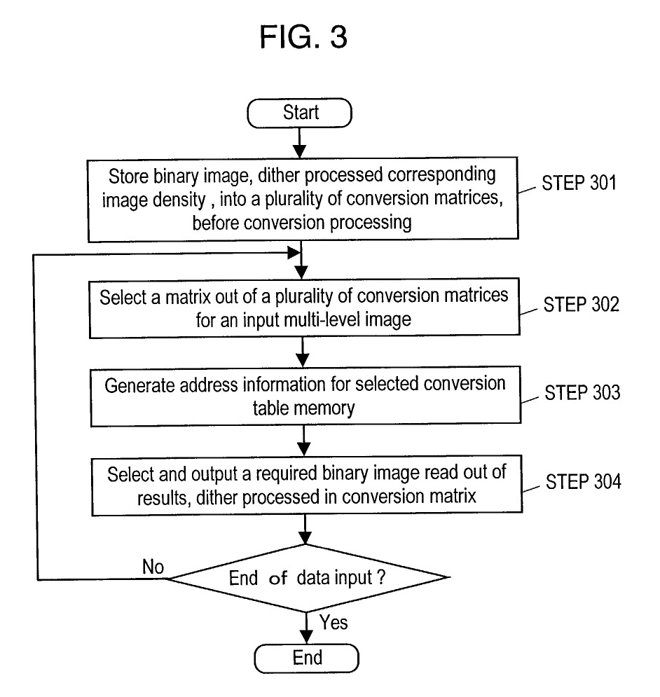

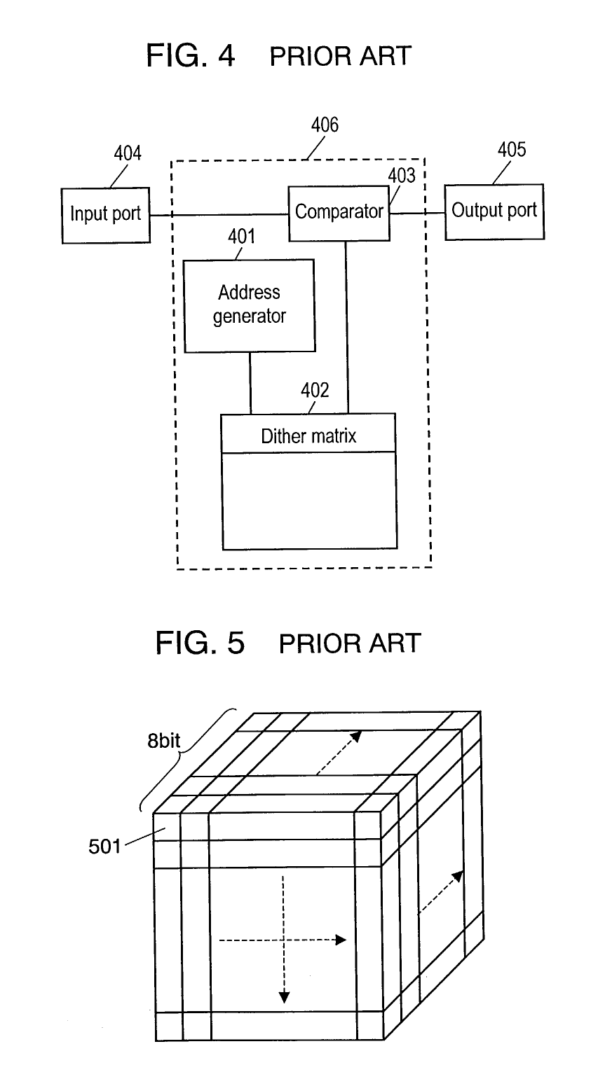

Next, a flow of processing in apparatus, having above configuration, for converting multi-level images into binary images is described with reference to flowchart shown in FIG. 3.

First, a binary image resulted from dither processing, corresponding image density, is stored in a plurality of conversion matrices, before the conversion process (step 301).

Next, a multi-level image is entered and one of conversion matrices 103 is selected (step 302).

Additionally, address information is generated for the selected table memory (step 303).

Finally, a required output binary image is selected among images read out of results from dither processing in conversion matrices (step 304).

Above conversion processes are executed from step 2 through step 4 repeatedly until end of data input.

As above mentioned, the conversion process disclosed in this invention needs to read out 1 bit data from a 1-bit conversion matrix to convert one pixel (1 bit data), since a binary image resulting from dither method processing is stored in the conversion matrix.

In a conventional art, conversion process needs to read out from dither matrix a threshold information having an identical bit length as input multi-level image, to maintain an original gradation of multi-level image. A data of 8 bits, for example, must be read out for 8-bit input multi-level image.

As above mentioned, the conversion process disclosed in this invention suppresses to read out a large amount of data, since results of dither processing is provided directly from a plurality of conversion matrices storing binary image data. Amount of data read out of conversion matrix is thus reduced than conventional arts.

Consequently, the image processing apparatus disclosed in this invention can perform a conversion processing efficiently in a reduced time due to a short read out time.

What is claimed is:

1. An image processing apparatus for converting a multi-level image into a binary image comprising:
(a) a plurality of conversion matrices to store binary image resulted from dither processing, corresponding image density;
(b) a conversion matrix selector to select a matrix out of the plurality of conversion matrices for an input multi-level image;
(c) an address generator to generate address information for the conversion matrix; and
(d) a data selector to select a required output binary image read out of results dither-processed in the conversion matrix.

2. A method of image processing for converting a multi-level image into a binary image comprising the steps of:
(a) storing binary image resulted from dither processing, corresponding to an image density, into a plurality of conversion matrices, before conversion processing;
(b) selecting a matrix out of the plurality of conversion matrices for an input multi-level image;
(c) generating address information for the selected conversion matrix; and
(d) selecting a required output binary image read out of results dither-processed in the conversion matrix.
